(19) United States
(12) Patent Application Publication
(10) Pub. No.: US 2023/0236922 A1
(43) Pub. Date: Jul. 27, 2023

(54) Failure Prediction Using Informational Logs and Golden Signals

(71) Applicant: International Business Machines Corporation, Armonk, NY (US)

(72) Inventors: Seema Nagar, Bangalore (IN); Rohan R. Arora, Danbury, CT (US); Bing Zhou, Rye, NY (US); Noah Zheutlin, White Plains, NY (US); Pooja Aggarwal, Bengaluru (IN); Amitkumar Manoharrao Paradkar, Mohegan Lake, NY (US); Larisa Shwartz, Greenwich, CT (US)

(73) Assignee: International Business Machines Corporation, Armonk, NY (US)

(21) Appl. No.: 17/582,493

(22) Filed: Jan. 24, 2022

(51) Int. Cl. G06F 11/07; G06F 11/34

(52) U.S. Cl. CPC G06F 11/0793; G06F 11/0712; G06F 11/3476; G06F 11/0781

(57) ABSTRACT

Embodiments relate to a computer platform to support processing of informational logs and corresponding performance data to detect and mitigate occurrence of anomalous behavior. Metrics are extracted from the informational logs and correlated with performance data, and in an exemplary embodiment golden signal metrics. A window or block of the logs is classified as potential candidates or indicators of anomalous behavior, which in an embodiment is indicative of potential failure or service outage. A control signal is dynamically issued to an operatively coupled device associated with the window or block of logs. The control signal is configured to selectively control a state of a physical device or process controlled by software, with the control directed at mitigating or eliminating the effect(s) of the anomalous behavior.

### BACKGROUND

The present embodiments relate to an artificial intelligence (AI) platform and associated methodology to leveraging informational logs to support failure prediction in a cloud native application. More specifically, the embodiments relate to inferring metrics from the leveraged information logs, and selectively applying a remediation to mitigate the predicted failure.

Cloud native applications are known in the art as software that is primarily access across a distributed network, such as the Internet. Such applications are at least partially managed by a remote server and not a local machine. The cloud application are often built on a distributed microservice architecture, which in an embodiment refers to a computer environment in which an application is built as a suite of modular components or services, each running its own process and communication by a lightweight mechanism. Generally, microservices are an architectural approach, often cloud native, in which a single application is composed of multiple loosely coupled and independently deployable smaller components or services, referred to as microservices. The microservices typically, but not necessarily, have their own stack, inclusive of a database and a data model, communicate with one another over a combination of operational state transfer (REST) application program interfaces (APIs), and are organized by business entity. Industrial microservice applications have hundreds or more microservices, some of which have dependent relationships.

The architectural style of the cloud native application, such as the microservice architecture, is beneficial with respect to simplifying development by delineating responsibilities and fostering reuse. Such applications can offer an experience of a locally installed program, but with reduced resource needs, convenient updating, and the ability to access functionality across devices. However, with the large quantity of elements, such as the microservices, in the cloud native application, prevention of a client impacting event (CIE), such as an outage or incident impacting availability of the cloud native application, is challenging and expensive.

### SUMMARY

The embodiments include a computer system, computer program product, and computer-implemented directed at incident prediction. More specifically, the embodiments are directed at mitigation or elimination of the predicted incident. Those embodiments are further described below in the Detailed Description. This Summary is neither intended to identify key features or essential features or concepts of the claimed subject matter nor to be used in any way that would limit the scope of the claimed subject matter.

In one aspect, a computer system is provided with a processing unit and memory for use with a platform to predict an event. The processing unit is operatively coupled to the memory and is in communication with the platform and embedded tools, which include a log manager, a processing manager, a classifier, and a director. The log manager functions to extract or otherwise identify performance data from informational logs. The processing manager, which is operatively coupled to the log manager, functions to map or otherwise associate the extracted performance data with a monitoring parameter, such as an operational characteristic. The classifier, which is operatively coupled to the processing manager, functions to compute a time series for the mapped performance data, and to selectively classify a window of the time series as a potential anomalous activity indicator. The director functions to leverage the selectively classified window for incident prediction. In an exemplary embodiment, the leverage of the selectively classified window supports identification of a resource saturation change. The director is configured to dynamically interface with the functionality of an operatively coupled device to mitigate or eliminate a predicted incident that is associated with the selectively classified window and corresponding potential anomalous activity indicator.

In another aspect, a computer program device is provided to support event prediction and outage mitigation. The program code is executable by a processor to extract or otherwise identify performance data from informational logs, and to map or otherwise associate the extracted performance data with a monitoring parameter, such as an operational characteristic. Program code is provided to compute a time series for the mapped performance data, and to selectively classify a window of the time series as a potential anomalous activity indicator. Program code is further provided to leverage the selectively classified window, which in an exemplary embodiment supports identification of a resource saturation change. The program code is configured to interface with the functionality of an operatively coupled device to mitigate or eliminate a predicted incident that is associated with the potential anomalous activity indicator.

In yet another aspect, a method is provided for supporting event prediction and outage mitigation. Performance data is extracted or otherwise identified from informational logs, and subject to mapping or association with a monitoring parameter, such as an operational characteristic. A time series is computed for the mapped performance data, and subject to processing with respect to a potential anomalous activity indicator. The time series data is leveraged for incident prediction, which in an embodiment supports identification of a resource saturation change. The leveraging of the time series data further comprises interfacing with functionality of an operatively coupled device to mitigate or eliminate a predicted incident that is associated with the selectively classified window and corresponding potential anomalous activity indicator.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a system diagram illustrating a knowledge platform computing system and tools to anomalous behavior prediction and detection.

FIG. 2 depicts a block diagram illustrating the knowledge platform and the associated tools, as shown and described in FIG. 1, and their associated application program interfaces.

FIG. 3 depicts a flow chart illustrating an overview of a process for incident prediction and an associated remediation process.

FIG. 4 depicts a flow chart illustrating a process for inferring metrics from informational logs.

FIG. 5 depicts a flow chart illustrating classifying a window as a potential indicator or early signal of a client impact event (CIE) using resource saturation trend identification.

FIG. 6 depicts a flow chart illustrating a process for classifying the window or block as an early indicator of an incident.

FIG. 7 depicts a flow chart illustrating a process for detecting a type of incident correlated with the event classification from FIG. 6.

FIG. 8 depicts a block diagram illustrating an example of a computer system/server of a cloud based support system, to implement the system and processes described above with respect to FIGS. 1-7.

FIG. 9 depicts a block diagram illustrating a cloud computer environment.

FIG. 10 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

It is understood that predicting operational outages or failures is challenging. Such prediction requires identification of a resource saturation or other preliminary signal that will likely lead to an operational outage, determining a lead time for predicting the operational outage, and minimizing false positives. As shown and described herein, informational logs are leveraged to support and enable incident prediction and selective remediation of the predicted operational aspect(s) of a cloud native application is provided. More specifically, the prediction aspect is directed at extracting metrics from the informational logs and correlating the extracted metrics with golden signals, or in an embodiment an alternative operational characteristic. The metrics are subject to processing to identify one or more potential outage indicators, and to selectively interface with the functionality of an operatively coupled device in an effort to mitigate the effects of the prediction, or an embodiment to eliminate the effects of the prediction prior to occurrence of the outage associated with the prediction.

A group of class or operational characteristics are defined herein as golden signals, which are known in the art as metrics directed at latency, traffic, errors, and saturation. In an embodiment, golden signals are classified into transactional and resource oriented, with latency, traffic and errors classified as transactional, and saturation classified as resource oriented. Latency is directed to service response delays and characterizes the time that it takes to service a request; latency is a key indicator of degradation in an application. Traffic is the amount of activity in the application. This value might be different depending on the characteristics of the application. Examples of traffic include, but are not limited to, the quantity of requests that an API handled, the quantity of connections to an application server, and the bandwidth that was consumed to stream an application. Errors are directed to the rate of requests that are failing, e.g. errors are measured in rates. In an exemplary embodiment, errors may expose bugs in the application, misconfigurations in a service, and dependency failures. Error rates can also affect other measurements, such as lowering latency or increasing saturation. Saturation characterizes service utilization with respect to its capacity. In an embodiment, saturation is measured by a heartbeat style associated with periodic monitoring. A few examples for determining saturation include: CPU and memory for all applications; disk I/O rates for databases and streaming applications; heap, memory, thread pool garbage collection for Java™ applications, and 99^{th} percentile for latency.

A log, also referred to herein as an informational log, is an automatically produced and time-stamped documentation of events relevant to a particular system. The logs represent a current stage of the computer system and operational components being utilized by one or more cloud native application. Logs are readily available with most cloud native application. As shown and described herein, a system, computer program product, and computer implemented method are configured to leverage informational logs to predict incidents and incident types in a cloud native application, and to selectively control an event injection to prevent, remediate, or mitigate the predicted incident(s).

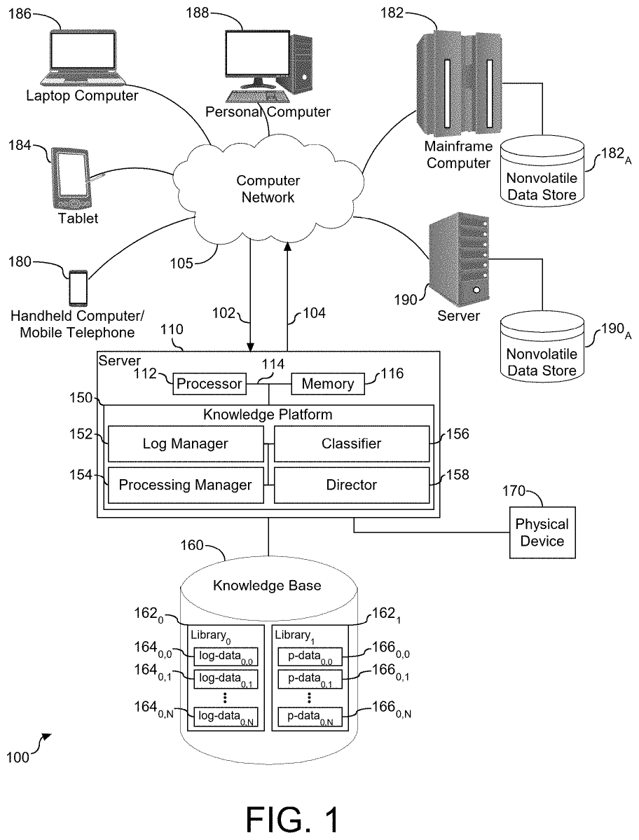

Referring to FIG. 1, a schematic diagram of a knowledge engine platform computing system (100) is depicted. As shown, a server (110) is provided in communication with a plurality of computing devices (180), (182), (184), (186), (188), and (190) across a network connection (105). The server (110) is configured with a processing unit (112), also referred to herein as a processor, operatively coupled to memory (116) across a bus (114). The server (110) is shown with a knowledge platform (150) configured with one or more tools to identify and leverage an operational characteristic to support and enable incident prediction. In an exemplary embodiment, the operational characteristic(s) are directed at one or more components of a golden signal. The computing devices (180), (182), (184), (186), (188), and (190) communicate with each other and with other devices or components via one or more wired and/or wireless data communication links, where each communication link may comprise one or more of wires, routers, switches, transmitters, receivers, or the like. In this networked arrangement, the server (110) and the network connection (105) enable communication detection, recognition, and resolution. Other embodiments of the server (110) may be used with components, systems, sub-systems, and/or devices other than those that are depicted herein.

The knowledge platform (150) is shown herein configured to receive input (102) from various sources. For example, the knowledge platform (150) may receive input across the network (105) and/or leverage a knowledge base (160), also referred to herein as a corpus or knowledge base. As shown, the knowledge base (160) is configured with one or more libraries. For exemplary purposes, the knowledge base (160) is shown herein with two libraries, referred to as a first library, library₀ (162₀), and a second library, library₁ (162₁). However, the quantity of libraries should not be considered limiting. In an embodiment, the knowledge base (160) may include multiple libraries which are organized or subject to organization by common subjects or themes, although this is not a requirement. The first library₀ (162₀) is configured to store information logs. In an embodiment, the informational logs are stored in groups shown herein as log data_{0,0} (164_{0,0}), log data_{0,1} (164_{0,1}), . . . , log data_{0,N} (164_{0,N}), with each group of logs related or directed to a physical device, microservice, software, etc. When subject to processing by the log manager (152), as described below, performance data is extracted from the informational logs. As shown herein by way of example, log data_{0,0} (164_{0,0}) has extracted performance data, p_data_{0,0} (166_{0,0}), log data_{0,1} (164_{0,1}) has extracted performance data, p_data_{0,0} (166_{0,1}), . . . , log data_{0,N} (164_{0,N}) has extracted performance data, p_data_{0,N} (166_{0,N}). The performance data is shown herein stored in the second library (162₁), although the location and storage of the performance data should not be considered limiting.

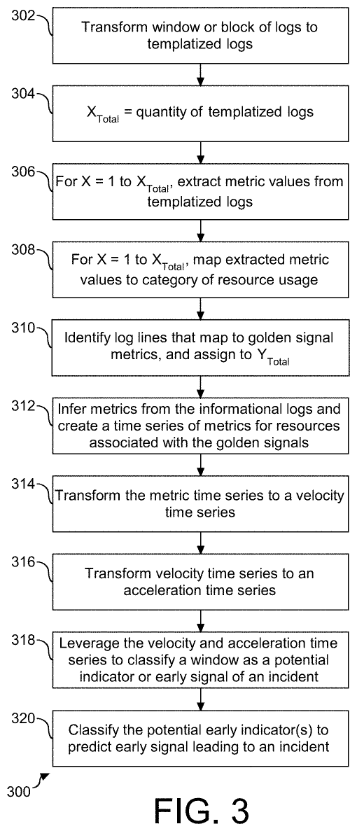

The knowledge platform (150) is provided with tools to support and enable incident prediction, and in an embodiment mitigating or elimination the predicted incident or negative aspects associated with the predicted incident. The tools function to leverage informational logs associated with one or more devices or application operatively connected to the server (110) across the network (105). The tools include, but are not limited to, a log manager (152), a processing manager (154), a classifier (156), and a director (158). The knowledge platform (150) may receive input across the network (105) and/or leverage the data source (160) to selectively process informational logs with respect to performance data, and to assess the performance data with respect to a potential outage indicator. As shown herein, the log manager (152) is configured to process informational logs, and in an exemplary embodiment to extract performance data from the informational logs. The extracted performance data is subject to processing. As shown herein, the processing manager (154), which is operatively coupled to the log manager (152), is configured to process the extracted performance data. More specifically, the processing manager (154) functions as a tool to map the extracted performance data to at least one monitoring parameter, which includes an operational characteristic. In an exemplary embodiment, the operational characteristic is a golden signal measurement that characterizes latency, traffic, errors, or saturation. Details of the functionality of the log manager (152) and the processing manager (154) are shown and described in FIG. 3. Accordingly, as shown herein, the log manager (152) and the processing manager (154) support extraction of performance data from information logs and mapping the extracted performance data to one or more monitoring parameters, respectively.

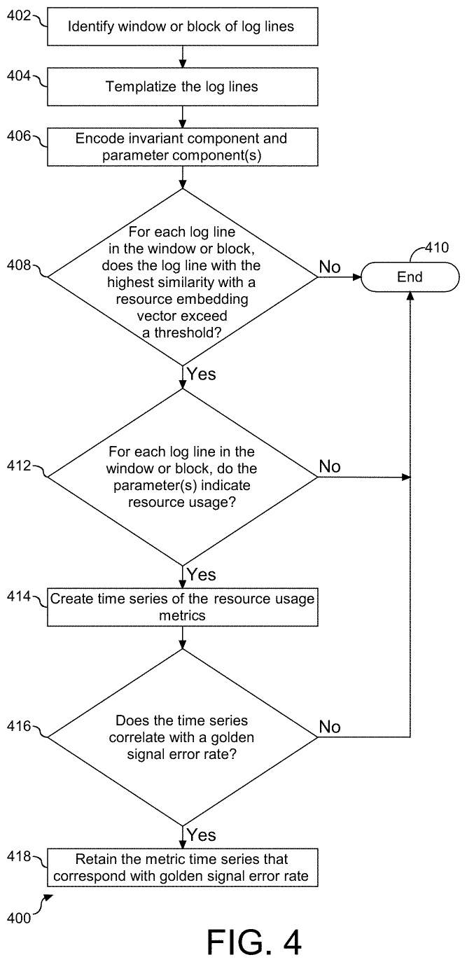

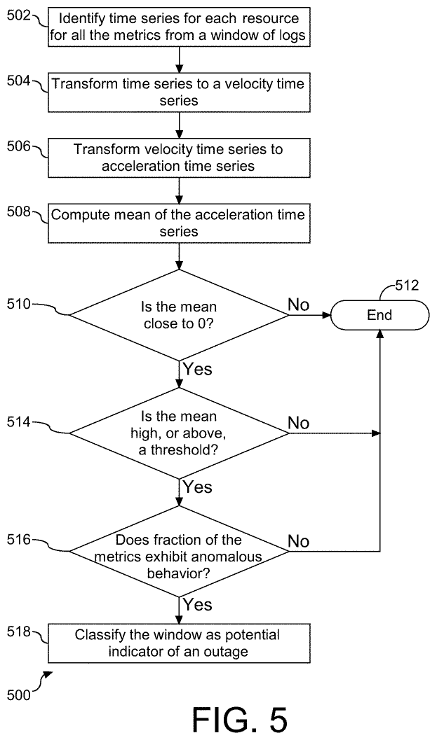

A classifier (156) is shown herein operatively coupled to the processing manager (154). The classifier (156) is configured to compute a time series, or in an embodiment a grouping of time series, for the mapped performance data, and is further configured to selectively classify a window of the time series groups as a potential outage indicator. Details of the time series processing and the window classification are shown and described in FIGS. 4 and 5. The window classification, or in an embodiment, the selectively classified window, is leveraged by the director (158) to manage or predict an incident. In an exemplary embodiment, the director (158) is configured to identify a resource saturation change, with saturation being a measure to characterize service utilization with respect to capacity. The director (158) is configured to interface with the classifier (156). More specifically, the classifier (156) is tasked with functionality to create a causal graph among candidate anomalous resources and associated metric time series. In an exemplary embodiment, a candidate anomalous resource may be a device, software, or process that is projected to experience an outage or performance degradation. The classifier (156) is further configured to apply clustering to the metrics that are represented in the causal graph, and to selectively classify at least one of the clusters as an indicator of the predicted incident. Accordingly, the classifier (156) and the director (158) function to process the time series data, which in an embodiment includes application of clustering techniques, to identify the predicted incident.

As shown herein, the director (158), which is operatively coupled to the classifier (156), functions to dynamically interface with an operatively coupled device, such as physical device (170), with respect to the incident prediction. The interface managed by the director (158) pertains to the functionality of the physical device (170), with the functionality modified to mitigate or in an embodiment eliminate the predicted incident prior to its occurrence. Although shown as a physical, in an exemplary embodiment, the device (170) may be a physical hardware device, a process controlled by software, or a combination of the device, process, and/or the software. In an exemplary embodiment, the director (158) is configured to dynamically issue a control signal that is commensurate or in alignment with aspects to mitigate or eliminate the predicted incident, with the control signal configured to selectively control a physical or operative state of the device (170), the process, and/or the software. In an exemplary embodiment the control signal, also referred to herein as an encoded action, facilitates or causes a change in an object state, physically transforming the object from a first state to a second state.

It is understood that informational logs may be received by one or more of the computing machines operatively coupled to the server (110) across the network (105). The informational logs or log data, may be placed or assigned to a library in the knowledge base (160), or in an embodiment, a new library may be created in the knowledge base (160). For example, in the case of a new product line, a new library within the knowledge base (160) may be appropriate to separate the new product line and associated informational logs from a prior product line. As shown herein, the knowledge base (160) is configured with libraries to store informational logs and corresponding extracted performance data as acquired or received from the various computing devices (180), (182), (184), (186), (188), and (190) in communication with the network (105).

As described herein, the knowledge platform (150) and corresponding tools (152)-(158) is operatively coupled to the knowledge base (160), which includes one or more libraries with informational logs subject to processing to identify associated performance data. The processing of the informational logs, and more specifically the mapping of the performance data to the monitoring parameters, may be conducted online or in an embodiment offline or as one or more background processes. The online processing of the performance data by the classifier (156) enables and supports real-time and dynamic interface between the director (158) and an operatively coupled device or process.

The functionality of the log manager (152), the processing manager (154), the classifier (156), and the director (158) is conducted in real-time to dynamically control issuance of a signal for selective interface with a device operatively associated with the corresponding informational logs and associated performance data. The director (158) is configured to selectively generate or issue a control signal to one or more of apparatus or software associated with the process, shown herein by way of example as device (170). For example, the director (158) may issue a control signal to modify, delay, or otherwise mitigate the effects of a procedure instruction on a corresponding physical apparatus or component thereof. Similarly, in an embodiment, the director (158) may directly interface with the physical device (170) to modify or physical transform a physical or operational state of the device (170) or corresponding object. In another exemplary embodiment, the apparatus or component may be a product dispenser and the issued signal may modify a functional characteristic of the product dispenser, either physically or in a virtual environment. In an embodiment, the director (158) computes a control action for a corresponding functional characteristic of the device (170) or corresponding object, and selectively generates the control signal based on the computed control action. The control action may be applied as a feedback signal to directly control an event injection to maximize a likelihood of realizing an event, which in one embodiment may be an event that cannot be directly controlled. Accordingly, the director (158) leverages the time series data as related to the informational log performance data and the computed time series data to selectively issue a control signal, or in an embodiment a feedback signal, to one or more physical devices in order to control an operational characteristic of a physical device or process to mitigate or eliminate a predicted incident.

The system and associated tools, as described herein, dynamically issues a signal, also referred to herein as a control signal, to control or modify an event injection to mitigate or eliminate an incident predicted from informational log performance data. As shown, the network (105) may include local network connections and remote connections in various embodiments, such that the knowledge platform (150) may operate in environments of any size, including local and global, e.g. the Internet. Additionally, the knowledge platform (150) serves as a front-end system that can make available a variety of knowledge extracted from or represented in network accessible sources and/or structured data sources. In this manner, some processes populate the knowledge platform (150), with the knowledge platform (150) also including input interfaces to receive requests and respond accordingly.

The network (105) may include local network connections and remote connections in various embodiments, such that the knowledge platform (150) may operate in environments of any size, including local and global, e.g. the Internet. Additionally, the knowledge platform (150) serves as a system that can make available a variety of knowledge extracted from or represented in network accessible sources and/or structured data sources. In this manner, some processes populate the knowledge platform (150), with the knowledge platform (150) also including one or more input interfaces or portals to receive requests and respond accordingly.

The knowledge platform (150) and the associated tools (152)-(158) leverage the knowledge base (160) and associated knowledge articles to support informational log processing, and to dynamically leverage the performance data to orchestrate one or more actions directed to device optimization. Device processing data received across the network (105) may be processed by a server (110), for example IBM Watson® server, and the corresponding knowledge platform (150). As shown herein, the knowledge platform (150) together with the embedded tools (152)-(158) perform an analysis of informational log data and dynamically generates one or more signals to physically modify a device or corresponding object state to mitigate or eliminate the effects of a predict incident. Accordingly, the function of the tools and corresponding analysis is to embed dynamic optimization of the physical object state to maintain or enhance operation thereof.

In some illustrative embodiments, the server (110) may be the IBM Watson® system available from International Business Machines Corporation of Armonk, N.Y., which is augmented with the mechanisms of the illustrative embodiments described hereafter. The tools (152)-(158) are shown as being embodied in or integrated within the knowledge platform (150) of the server (110). The tools (152)-(158) may be implemented in a separate computing system (e.g., 190), or in one embodiment they can be implemented in one or more systems connected across network (105) to the server (110). Wherever embodied, the tools function to dynamically optimize device operation.

Types of devices and corresponding systems that can utilize the artificial intelligence platform (150) range from small handheld devices, such as handheld computer/mobile telephone (180) to large mainframe systems, such as mainframe computer (182). Examples of handheld computer (180) include personal digital assistants (PDAs), personal entertainment devices, such as MP4 players, portable televisions, and compact disc players. Other examples of information handling systems include pen, or tablet computer (184), laptop, or notebook computer (186), personal computer system (188), and server (190). As shown, the various devices and systems can be networked together using computer network (105). Types of computer network (105) that can be used to interconnect the various devices and systems include Local Area Networks (LANs), Wireless Local Area Networks (WLANs), the Internet, the Public Switched Telephone Network (PSTN), other wireless networks, and any other network topology that can be used to interconnect the devices and systems. Many of the devices and systems include nonvolatile data stores, such as hard drives and/or nonvolatile memory. Some of the devices and systems may use separate nonvolatile data stores (e.g., server (190) utilizes nonvolatile data store (190_{A}), and mainframe computer (182) utilizes nonvolatile data store (182_{A}). The nonvolatile data store (182_{A}) can be a component that is external to the various devices and systems or can be internal to one of the devices and systems.

The device(s) and system(s) employed to support the knowledge platform (150) may take many forms, some of which are shown in FIG. 1. For example, an information handling system may take the form of a desktop, server, portable, laptop, notebook, or other form factor computer or data processing system. In addition, the device(s) and system(s) may take other form factors such as a personal digital assistant (PDA), a gaming device, ATM machine, a portable telephone device, a communication device or other devices that include a processor and memory.

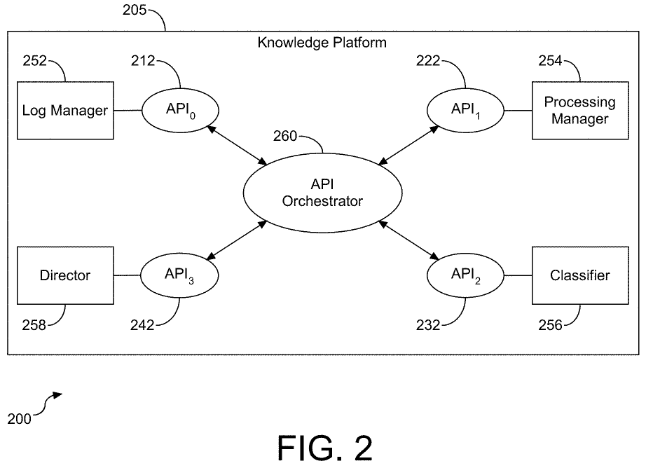

An Application Program Interface (API) is understood in the art as a software intermediary between two or more applications. With respect to the knowledge platform (150) shown and described in FIG. 1, one or more APIs may be utilized to support one or more of the tools (152)-(158) and their associated functionality. Referring to FIG. 2, a block diagram (200) is provided illustrating the tools (252)-(258) and their associated APIs. As shown, a plurality of tools is embedded within the knowledge platform (205), with the tools including the log manager (152) shown herein as (252) associated with API₀ (212), the processing manager (154) shown herein as (254) associated with API₁ (222), the classifier (156) shown herein as (256) associated with API₂ (232), and the director (158) shown herein as (258) associated with API₃ (242).

Each of the APIs may be implemented in one or more languages and interface specifications. API₀ (212) provides functional support to interface with one or more informational logs and to extract performance data from the logs; API₁ (222) provides functional support for mapping the performance data to a monitoring parameter, such as an operational characteristic of a device or process; API₂ (232) provides functional support for computing and processing time series data for the performance data, and to selectively classify one or more windows of the time series data as a potential incident indicator; and API₃ (242) provides functional support for dynamically issuing a control signal to an operatively coupled physical device that is associated with the incident indicator, with the signal configured to mitigate or eliminate occurrence of the predicted incident. As shown, each of the APIs (212), (222), (232), and (242) are operatively coupled to an API orchestrator (260), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

Referring to FIG. 3, a flow chart (300) is provided to illustrate an overview of the incident prediction and an associated remediation process. The initial aspect of incident prediction is directed at inferring metrics from informational logs. A detailed description of inferring metrics is shown and described in FIG. 4. It is understood that there may be an abundant quantity of logs lines, some of which may be relevant with respect to an incident prediction assessment, and some of which may be irrelevant with respect to the incident prediction assessment. In addition, it is further understood that the logs lines are verbose in nature. The act of creating a template and populating the template with data is referred to herein as templatization. Given a window or block of logs, the logs are subject to templatization to transform the logs to templatized logs (302). In an embodiment, natural language processing (NLP) is employed to support and enable the log transformation at step (302). In an exemplary embodiment, every log line has an invariant and one or more parameters. The transformation at step (302) identifies both components, e.g. the invariant and the one or more parameters, of the log lines. The quantity of templatized log lines is assigned to the variable X_{Total} (304). For each templatized log line, from X=1 to X_{Total}, metric values are extracted (306). In addition, each templatized log line, from X=1 to X_{Total}, is mapped to a category of resource usage, such as, but not limited to, memory usage, CPU usage, etc. (308). In an exemplary embodiment, the resource mapping at step (308) is supported through NLP, where the parameters identified at step (302) are mapped to corresponding resources at step (308). Accordingly, the initial log processing is directed at transformation, metric extraction, and mapping.

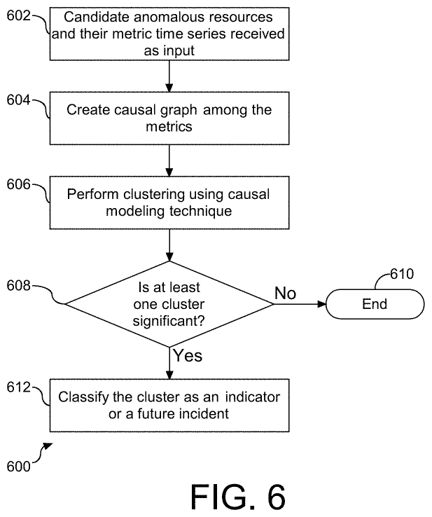

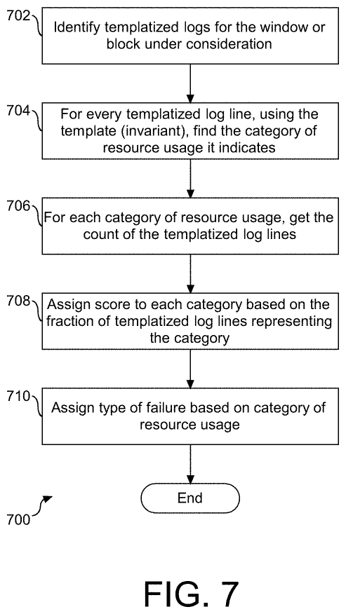

As shown and described herein, in an exemplary embodiment the incident prediction is correlated with golden signals, and more specifically golden signal metrics. In an embodiment, the incident prediction may be correlated with other signals, and as such the golden signal metric(s) correlation should not be considered limiting. Following step (308), the templatized and mapped log lines are assessed to identify those log lines that map to one or more of golden signal metrics, and to assign those identified log lines to the variable Y_{Total} (310). In an exemplary embodiment, the templatized and mapped log lines are filtered or subject to a filtering process at step (310) to identify those log lines that are directed at the golden signal metrics. In an embodiment, a subset of log lines from X_{Total} may be populated into the assignment at step (310), e.g. Y_{Total} may be less than or equal to X_{Total}. Following step (308) and using the subset identified at step (310), metrics are inferred from the informational logs creating a time series of metrics for resources associated with the golden signals (312). In an embodiment, the time series is a sequence of data values measured at successive, though not necessarily, regular points in time. The metric time series are transformed to a velocity time series (314), e.g. rate of change, and are further transformed to an acceleration time series (316), e.g. rate of change of velocity. The time series data, including the velocity time series and the acceleration time series, are leveraged to classify a window as a potential indicator or early signal of an incident (318). Details of the window classification process are shown and described in FIG. 5. The potential early indicator(s) from step (318) are classified or subject to classification to predict early signals leading to an incident (320). Details of the classification process are shown and described in FIG. 6. Using the classification, a prediction for an incident type is selectively detected. Details of the incident prediction and associated physical actions are shown and described in FIG. 7.

Referring to FIG. 4, a flow chart (400) is provided to illustrate a process for inferring metrics from informational logs. As shown in FIG. 3, a window or block of log lines, herein after referred to as logs, is identified (402). The log lines in the window or block are subject to templatization to transform the log lines, with the templatization including identification of an invariant component and one or more parameter components (404). The invariant component for each of the log lines in the window or block is encoded or subject to encoding (406). In an exemplary embodiment, the encoding is in the form of a text encoder that creates a vector or vector representation for the invariant component identified in the log lines. In an embodiment, a different form or format of text encoding may be employed, and as such, the vector encoding and representation should not be considered limiting. For each log line in the window or block, an assessment is conducted to determine if the log line with the highest similarity with a resource embedding vector exceeds a threshold (408). A negative response to the determination concludes the process of inferring metrics from informational logs (410). However, a positive response to the determination at step (408) is followed by a subsequent assessment to further assess the parameters, which in an embodiment is shown herein by determining for each of the log lines if the parameters indicate resource usage (412). A negative response to the assessment is following by conclusion of the process of inferring metrics (410). However, a positive response to the determination at step (412) is followed by creating a time series of the resource usage metrics (414). In an exemplary embodiment, the assessment at step (412) is directed at retention of the numeric parameters, which may be subject to filtering based on their frequency of occurrence in the logs. For example, if a parameter is a transaction identifier or a request identifier, then chance of occurrence is high, while re-occurrence of memory utilization reaching about 80% is low. Accordingly, from the retained numeric parameters, those most probably for resource usage are retainer, and using the resource indicated in the log line, a time series of metrics is generated for the resource.

Following the creation of the time series at step (414), an assessment is conducted to correlate the time series with a golden signal error rate (416). More specifically, the assessment at step (416) is directed at only retaining time series data that correlates, or in an exemplary embodiment highly correlates, with golden signal metric time series. If the determination at step (416) indicates that there is no correlation present, then the process returns to step (410) to conclude the metric inference for the block or window of informational logs. However, a positive response to the determination at step (416) is following by retaining the metric time series that is identified as having a golden signal correlation, or in an embodiment a high correlation (418. Accordingly, as shown herein time series of metrics for the resources are inferred from the informational logs.

Referring to FIG. 5, a flow chart (500) is provided to illustrate a process for classifying a window as a potential indicator or early signal of a client impact event (CIE) using resource saturation trend identification. As shown, the time series for each resource for all the metrics from a window of logs is identified (502). In an embodiment, the identified time series is obtained from the output of the process shown and described in FIG. 4. The time series is transformed to a velocity time series directed at rate of change (504), which is transformed to acceleration time series directed at the rate of change of the velocity (506). Accordingly, at steps (504) and (506), respectively, the time series data from step (502) is transformed for every resource and every metric to velocity and acceleration time series. In an embodiment, extensibility of the resource is determined based on information available via application program interfaces (APIs), which in an embodiment may be provided by a distributed resource provider. Following step (506). The mean of the acceleration time series is computed as a measure of the associated data (508). In an embodiment, an alternative statistical metric may be utilized in place of or in addition to the mean, including, but not limited to median and mode. In an exemplary embodiment, the mean is an average of the data. Using the mean, or in an embodiment a different statistical value of the acceleration time series, it is then determined if the acceleration mean is at or near zero (510). If the mean is at or near zero, then the metric is classified as not exhibiting anomalous behavior and the classification process concludes (512). Similarly, if the mean is not at or near zero, then the metric is classified as exhibiting, or in an embodiment potentially exhibiting anomalous behavior, and the classification process continues. Accordingly, the initial acceleration time series evaluation is directed to statistical evaluation and association of the evaluation with anomalous behavior.

If at step (510) it is determined that the acceleration time series exhibits or may exhibit anomalous behavior, a subsequent assessment is conducted to determine if the mean is high, or in an embodiment exceeds a configurable threshold (514). Similar to the assessment at step (510), a positive response to the assessment at step (514) is an indication that the metric is or may be exhibiting anomalous behavior. Conversely, a negative response to the assessment at step (514) is an indication that the metric is not exhibiting anomalous behavior and the classification process concludes (512). A positive response to the assessment at step (514) is followed by identifying a degree of anomaly, such as severity level of the anomaly. As shown herein, an assessment is conducted to determine if a fraction of the metrics exhibit anomalous behavior (516). A negative response to the assessment is followed by a conclusion of the classification process (512), and a positive response is followed by classification of the window or block as a potential indicator of an incident (518). In an exemplary embodiment, the incident may be in the form of an outage. Accordingly, the acceleration time series is subject to statistical evaluation(s) to ascertain or identify characteristics associated with anomalous behavior.

Referring to FIG. 6, a flow chart (600) is provided to illustrate a process for classifying the window or block as an early indicator of an incident. Input for this process is in the form of candidate anomalous resources and their metric time series (602), which in an embodiment is identified in the process shown in FIG. 5. The time series metrics are subject to causal modeling to generate a causal graph among the metrics (604). Thereafter, the generated causal graph is used to perform clustering (606), which in an embodiment leverages a causal modeling technique. In an embodiment, in place of causal modeling an alternative relationship technique may be utilized. The clusters representing in the clustering are assessed to determine if at least one cluster is significant (608). In an embodiment, the significance assessment may be in the form of the cluster having greater than k percent of the metric, where k is a configurable value. A negative response to the assessment concludes the classification of an early indicator (610). However, a positive response to the assessment is followed by classifying the identified cluster, and more specifically, the represented window or block, as an indicator or signal of a future incident (612). In an embodiment, more than one cluster may be identified at step (608), in which case each cluster would be subject to the classification at step (612). Accordingly, the time series data is subject to further processing and assessment directed at classification of a signal of an event prior to occurrence.

As shown in FIG. 6, a window or block is identified at an indicator or signal of an event based on processing of time series. Referring to FIG. 7, a flow chart (700) is provided to illustrate a process for detecting a type of incident correlated with the event classification from FIG. 6. As shown, a set of templatized logs for the window or block under consideration are identified (702). The set of logs are processed or subject to processing to leverage the template invariant to find the category of resource usage indicated (704), as shown in FIG. 3. In an embodiment, log lines that do not correlate with a resource usage category are not considered. For each category of resource usage identified from the processed logs, a count of the templatized log lines is obtained (706). A score is assigned to each category of resource based on a fraction of templatized log line represented in the category (708). For example, if there are a total of 100 log lines, from which 20 indicate a memory issue and 50 indicate a processor issue, then the memory issue fraction is 20/100, e.g. 20%, and the processor issue is 50/100, e.g. 50%. Based on this example, the processor issue has a higher fraction or percentage indicator or value than the memory issue fraction or percentage. A failure type is assigned based on the category of resource usage, which in an embodiment is based on a count of templates corresponding to each category of usage, (710). Examples of types of failure include, but are not limited to, memory, processor, or bandwidth. In an embodiment, the assignment at step (710) is based on the highest important. Accordingly, the incident prediction from FIG. 6 is categorized into an incident type.

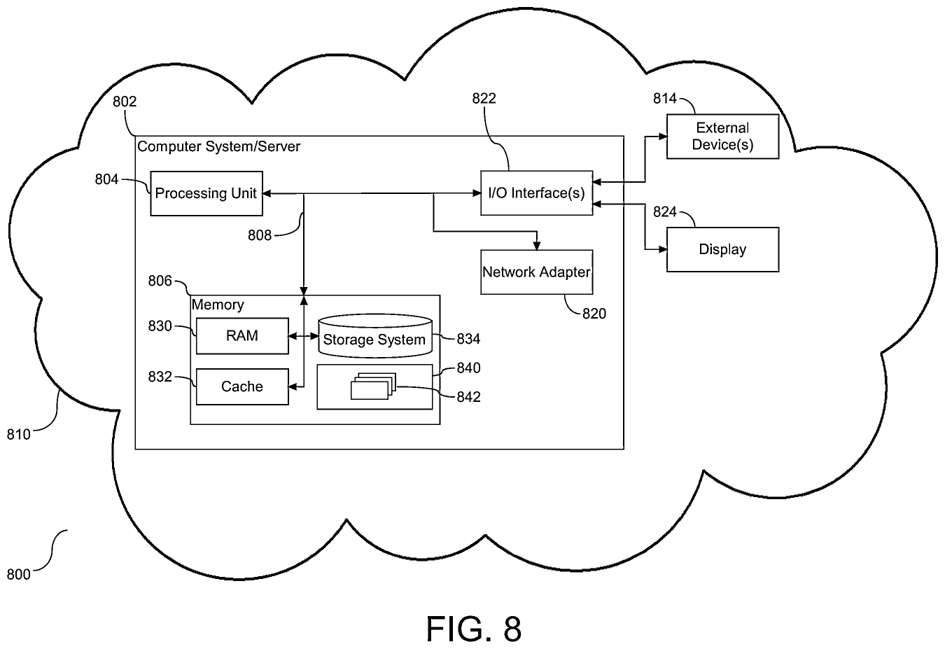

Embodiments shown and described herein may be in the form of a computer system for use with an intelligent computer platform for providing orchestration of activities across one or more domains to minimize risk. Aspects of the tools (152)-(158) and their associated functionality may be embodied in a computer system/server in a single location, or in one embodiment, may be configured in a cloud based system sharing computing resources. With reference to FIG. 8, a block diagram (800) is provided illustrating an example of a computer system/server (802), hereinafter referred to as a host (802) in a cloud computing environment (810), to implement the system, tools, and processes described above with respect to FIGS. 3-7. Host (802) is operational with numerous other general purpose or special purpose computing system environments or configurations. Examples of well-known computing systems, environments, and/or configurations that may be suitable for use with host (802) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (802) may be described in the general context of computer system-executable instructions, such as program modules, being executed by a computer system. Generally, program modules may include routines, programs, objects, components, logic, data structures, and so on that perform particular tasks or implement particular abstract data types. Host (802) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, host (802) is shown in the form of a general-purpose computing device. The components of host (802) may include, but are not limited to, one or more processors or processing units (804), e.g. hardware processors, a system memory (806), and a bus (808) that couples various system components including system memory (806) to processor (804). Bus (808) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (802) typically includes a variety of computer system readable media. Such media may be any available media that is accessible by host (802) and it includes both volatile and non-volatile media, removable and non-removable media.

Memory (806) can include computer system readable media in the form of volatile memory, such as random access memory (RAM) (830) and/or cache memory (832). By way of example only, storage system (834) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (808) by one or more data media interfaces.

Program/utility (840), having a set (at least one) of program modules (842), may be stored in memory (806) by way of example, and not limitation, as well as an operating system, one or more application programs, other program modules, and program data. Each of the operating systems, one or more application programs, other program modules, and program data or some combination thereof, may include an implementation of a networking environment. Program modules (842) generally carry out the functions and/or methodologies of embodiments to dynamically orchestrate of activities across one or more domains to minimize risk. For example, the set of program modules (842) may include the tools (152)-(156) as described in FIG. 1.

Host (802) may also communicate with one or more external devices (814), such as a keyboard, a pointing device, etc.; a display (824); one or more devices that enable a user to interact with host (802); and/or any devices (e.g., network card, modem, etc.) that enable host (802) to communicate with one or more other computing devices. Such communication can occur via Input/Output (I/O) interface(s) (822). Still yet, host (802) can communicate with one or more networks such as a local area network (LAN), a general wide area network (WAN), and/or a public network (e.g., the Internet) via network adapter (820). As depicted, network adapter (820) communicates with the other components of host (802) via bus (808). In one embodiment, a plurality of nodes of a distributed file system (not shown) is in communication with the host (802) via the I/O interface (822) or via the network adapter (820). It should be understood that although not shown, other hardware and/or software components could be used in conjunction with host (802). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (806), including RAM (830), cache (832), and storage system (834), such as a removable storage drive and a hard disk installed in a hard disk drive.

Computer programs (also called computer control logic) are stored in memory (806). Computer programs may also be received via a communication interface, such as network adapter (820). Such computer programs, when run, enable the computer system to perform the features of the present embodiments as discussed herein. In particular, the computer programs, when run, enable the processing unit (804) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

In one embodiment, host (802) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

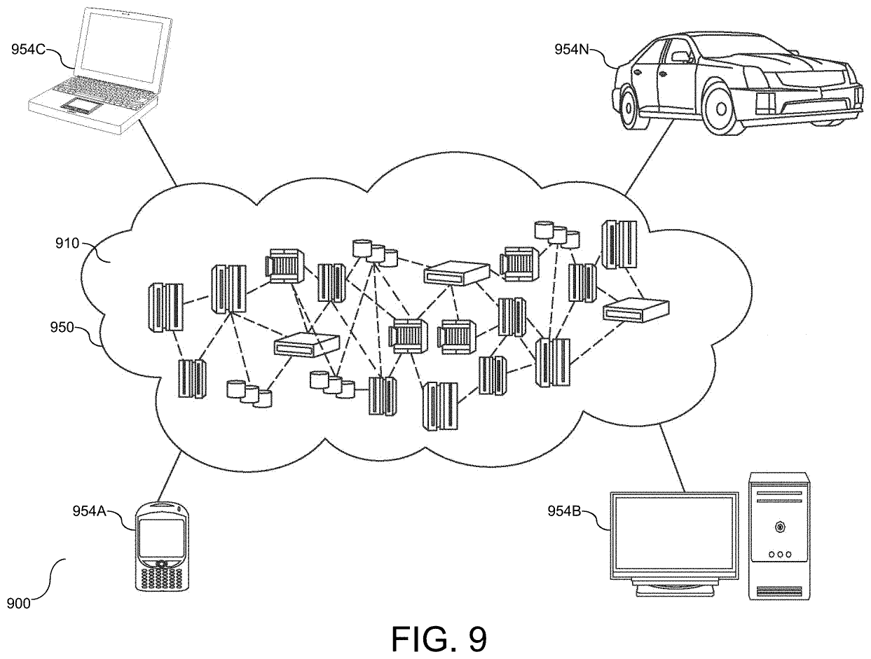

Referring now to FIG. 9, an illustrative cloud computing network (900). As shown, cloud computing network (900) includes a cloud computing environment (950) having one or more cloud computing nodes (910) with which local computing devices used by cloud consumers may communicate. Examples of these local computing devices include, but are not limited to, personal digital assistant (PDA) or cellular telephone (954A), desktop computer (954B), laptop computer (954C), and/or automobile computer system (954N). Individual nodes within nodes (910) may further communicate with one another. They may be grouped (not shown) physically or virtually, in one or more networks, such as Private, Community, Public, or Hybrid clouds as described hereinabove, or a combination thereof. This allows cloud computing environment (900) to offer infrastructure, platforms and/or software as services for which a cloud consumer does not need to maintain resources on a local computing device. It is understood that the types of computing devices (954A-N) shown in FIG. 9 are intended to be illustrative only and that the cloud computing environment (950) can communicate with any type of computerized device over any type of network and/or network addressable connection (e.g., using a web browser).

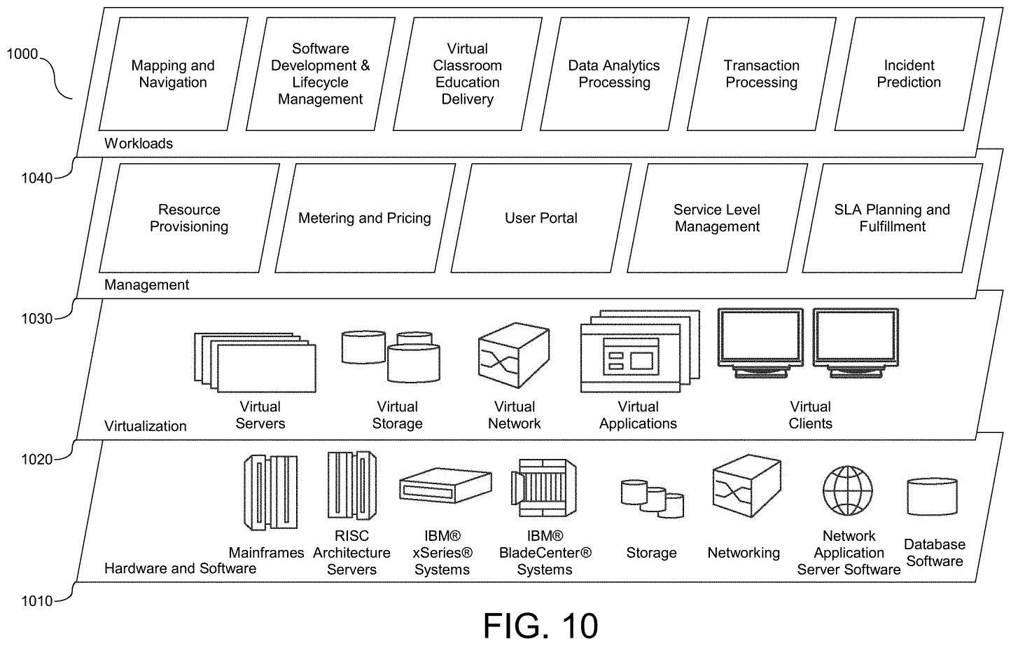

Referring now to FIG. 10, a set of functional abstraction layers (1000) provided by the cloud computing network of FIG. 9 is shown. It should be understood in advance that the components, layers, and functions shown in FIG. 10 are intended to be illustrative only, and the embodiments are not limited thereto. As depicted, the following layers and corresponding functions are provided: hardware and software layer (1010), virtualization layer (1020), management layer (1030), and workload layer (1040).

The hardware and software layer (1010) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (1020) provides an abstraction layer from which the following examples of virtual entities may be provided: virtual servers; virtual storage; virtual networks, including virtual private networks; virtual applications and operating systems; and virtual clients.

In one example, management layer (1030) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (1040) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and incident prediction.

It will be appreciated that there is disclosed herein a system, method, apparatus, and computer program product for evaluating informational logs, including utilizing natural language input in the processing and evaluation of the informational logs, detecting or projecting anomalous system or process behavior as associated with performance data gathered from the informational logs, and selectively and dynamically dictating a control signal to a physical device, process, and/or software to eliminate or mitigate the anomalous behavior of the effects thereof.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments.

Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product are operative to improve the functionality and operation of a computer system as supported by knowledge platform driven processing of informational logs for incident prediction and mitigation.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. In particular, the informational log process, performance data evaluation, and the selectively and dynamic issuance of a signal may be carried out by different computing platforms or across multiple devices. Furthermore, the data storage and/or corpus may be localized, remote, or spread across multiple systems. Accordingly, the scope of protection of the embodiments is limited only by the following claims and their equivalents.

What is claimed is:

1. A computer system comprising:
a processor operatively coupled to memory;
a platform, operatively coupled to the processor, and configured to predict an incident, the platform comprising;
a log manager configured to extract performance data from informational logs;
a processing manager, operatively coupled to the log manager, and configured to map the extracted performance data to one or more monitoring parameters, wherein the one or more monitoring parameters includes an operational characteristic;
a classifier, operatively coupled to the processing manager, and configured to compute a time series for the mapped performance data, and selectively classify a window of the time series as a potential anomalous activity indicator; and
a director, operatively coupled to the classifier, and configured to leverage the selectively classified window for incident prediction, including dynamically interface with functionality of an operatively coupled device to mitigate or eliminate the predicted incident.

2. The computer system of claim 1, further comprising the director configured to dynamically configure and issue a control signal to the operatively coupled device, the control signal commensurate with the mitigation or elimination of the predicted incident, and the operatively couple device being a physical hardware device, a process controlled by software, or a combination thereof, and the control signal configured to selectively control a physical state of the operatively coupled device, the software, or a combination thereof.

3. The computer system of claim 1, wherein leveraging the computed time series data further comprises the director configured to identify a resource saturation change.

4. The computer system of claim 3, wherein the selective window classification as a potential anomalous activity indicator further comprises the classifier configured to create a causal graph among candidate anomalous resources and associated metric time series.

5. The computer system of claim 4, further comprising the classifier configured to apply clustering to metrics represented in the causal graph, and selectively classify at least one cluster as an indicator of the predicted incident.

6. The computer system of claim 1, wherein the operational characteristic is a golden signal measurement characterizing latency, traffic, errors, saturation, or a combination thereof.

7. A computer program product configured to interface with a computer readable storage medium having program code embodied therewith, the program code executable by a processor to:
extract performance data from informational logs;
map the extracted performance data to one or more monitoring parameters, wherein the one or more monitoring parameters includes an operational characteristic;
compute a time series for the mapped performance data, and selectively classify a window of the time series as a potential anomalous activity indicator; and
leverage the computed time series data for incident prediction, including dynamically interface with functionality of an operatively coupled device to mitigate or eliminate the predicted incident.

8. The computer program product of claim 7, further comprising program code configured to dynamically configure and issue a control signal to the operatively coupled device, the control signal commensurate with the mitigation or elimination of the predicted incident, and the operatively couple device being a physical hardware device, a process controlled by software, or a combination thereof, and the control signal configured to selectively control a physical state of the operatively coupled device, the software, or a combination thereof.

9. The computer program product of claim 7, wherein the program code configured to leverage the computed time series data further comprises program code configured to identify a resource saturation change.

10. The computer program product of claim 9, wherein the program code to selectively classify the window as a potential anomalous activity indicator further comprises program code configured to create a causal graph among candidate anomalous resources and associated metric time series.

11. The computer program product of claim 10, further comprising program code configured to apply clustering to metrics represented in the causal graph, and selectively classify at least one cluster as an indicator of the predicted incident.

12. The computer program product of claim 7, wherein the operational characteristic is a golden signal measurement characterizing latency, traffic, errors, saturation, or a combination thereof.

13. A computer implemented method for incident prediction, comprising;
extracting performance data from informational logs;
mapping the extracted performance data to one or more monitoring parameters, wherein the one or more monitoring parameters includes an operational characteristic;
computing a time series for the mapped performance data, and selectively classifying a window of the time series as a potential anomalous activity indicator; and
leveraging the computed time series data for incident prediction, including dynamically interfacing with functionality of an operatively coupled device to mitigate or eliminate the predicted incident.

14. The method of claim 13, further comprising dynamically configuring and issuing a control signal to the operatively coupled device, the control signal commensurate with the mitigation or elimination of the predicted incident, and the operatively couple device being a physical hardware device, a process controlled by software, or a combination thereof, and the control signal configured to selectively control a physical state of the operatively coupled device, the software, or a combination thereof.

15. The method of claim 13, wherein leveraging the computed time series data further comprises identifying a resource saturation change.

16. The method of claim 15, wherein selectively classifying the window as a potential anomalous activity indicator further comprises creating a causal graph among candidate anomalous resources and associated metric time series.

17. The method of claim 16, further comprising applying clustering to metrics represented in the causal graph, and selectively classifying at least one cluster as an indicator of the predicted incident.

18. The method of claim 13, wherein the operational characteristic is a golden signal measurement characterizing latency, traffic, errors, saturation, or a combination thereof.
